(19) United States
(12) Patent Application Publication
(10) Pub. No.: US 2019/0270517 A1
(43) Pub. Date: Sep. 5, 2019

(54) VERTICAL TAKE-OFF AND LANDING AIRCRAFT

(71) Applicant: MONO AEROSPACE IP LTD, London (GB)

(72) Inventor: Brian Morgan, London (GB)

(21) Appl. No.: 16/345,238

(22) PCT Filed: Oct. 27, 2017
(86) PCT No.: PCT/GB2017/053247

§ 371 Date: Apr. 25, 2019

(30) Foreign Application Priority Data
Oct. 27, 2016 (GB) 1618199.2

(51) Int. Cl. B64C 29/00; B64C 11/00; B64C 11/46; B64C 23/06; B64C 7/02; B64C 9/02; B64C 9/22

(52) U.S. Cl. CPC B64C 29/0025; B64C 11/001; B64C 11/46; B64D 27/14; B64C 7/02; B64C 9/02; B64C 9/22; B64C 23/06

(57) ABSTRACT

A lift rotor or ‘thrust’ system or assembly for a VTOL aircraft, comprising first and second lifting thrusters or rotors contained within a housing, the housing containing a leading edge, a trailing edge, a upper surface and a lower surface; wherein the housing includes one or more airflow manipulation devices provided on or associated with the housing configured to manage the airflow into or through at least one of the first and second rotors. In other aspects, the invention embraces an aircraft wing including a lift thruster system as defined above, and also an aircraft comprising such a lift thruster system.

### FIELD OF THE INVENTION

The invention is directed to schemes for vertical take-off and landing aircraft (VTOL) and control techniques for such aircraft. Embodiments of the invention relate to a lift assembly for an aircraft, and to an aircraft incorporating a lift assembly.

### BACKGROUND TO THE INVENTION

There are many different types of VTOL aircraft designs. One well known method for accomplishing VTOL flight is via tilt-rotor designs (e.g. V22 Osprey) where typically two or more larger propellers or rotors are mounted on pivoting axles at the ends of wingspans on these aircraft, and they then tilt or pivot from vertical orientation for lift off, to horizontal orientations as they transition through and enter normal forward flight mode. One of the major downfalls of this design is the dangerous time while the rotors are slowly tilting toward forward flight orientation. As the rotors tilt, their overall vertical lift force that was supporting the aircraft's weight is quickly reduced while the wings do not yet have sufficient lift force generated yet during the relatively slow transition to the forward flight speed needed. In these moments small anomalies, changes in wind speed or direction can stall the rotor(s), which is a possibly aircraft fatal condition for just a two-rotor equipped machine.

Another method of VTOL execution used on other designs is called redirected thrust augmentation. This is conceptually the same as a tilt rotor scheme concerning the underlying physics to balance the airframes in each case, but these aircraft are typically powered by turbofan or turbojet engines producing tremendous amounts of thrust instead of larger exposed rotor systems. The raw thrust is directed downward for vertical take-off and hovering and then “redirected” (tilted) rearward to drive the plane into forward flight. The same type of danger exists for redirected thrust type designs as they tilt thrust away from supporting the aircraft, but this concern is sometimes reduced due to the typically huge horsepower to weight ratio differences of these airframes. The Harrier fighter jet (British military's AV8 Harrier) is probably the best example of this type of VTOL design. There are other previously considered methods and systems which describe similar airframe designs having horizontal and vertical flight, take-off and landing function.

One such previously considered system described in U.S. Pat. No. 6,843,447 depicts a fixed wing airframe but with rotors systems only enclosed in larger inner wing sections or housings that are immediately adjacent to a strictly centre-mass type fuselage, and aft-wing mounted thrusters. U.S. Pat. No. 5,890,441 describes an unmanned aerial vehicle of both vertical and horizontal flight characteristics, but employing two main fuselage-mounted and equally-spaced rotor systems surrounding the typical centre of gravity of the design. The aircraft described in these documents are sometimes referred to as ‘enclosed rotor’ designs and characteristically feature very high rotor loadings and, for this reason, are also sometimes referred to as Very High Disk Load (VHDL) aircraft, having disk loads in excess of 100 pounds per square foot. While these very high disk load (VHDL) rotor systems are comparably less efficient during hover operations, they in-turn offer significant advantages due to the nature of the aerodynamics at work. Further advantages of this type of aircraft configuration are: flexibility—the aircraft is far less affected by adverse weather conditions or higher winds, since exit velocities of the lift rotor air streams are more concentrated and not as affected by otherwise troublesome cross winds; forward flight efficiency—once converted to forward flight mode, such aircraft are able to cruise at significantly higher speeds than any traditional rotorcraft (as much as 3× or more) while also benefiting from the other known advantages of wing born flight such as extended range via speed and reduced wing loading (exchanged for high disk load hover) and the ability to fly at higher altitudes, which also provides the option to fly over adverse weather conditions as well, unlike helicopters.; safety—comfort and the additional safety/redundancy of having wings allows the aircraft to glide to safe landings should there be engines or VTOL systems failures.

Whilst VHDL aircraft like the ones described above certainly have their advantages, controlling the aircraft is challenging, particularly with the high velocity airflow that is entering the rotors ducting within the wings, which can induce challenging aerodynamic effects during flight, and between operational flight modes. It is against this background that the embodiments of the invention have been devised.

### SUMMARY OF THE INVENTION

In one aspect, the embodiments of the invention provide a lift thruster assembly for a VTOL aircraft, comprising one or more lifting thrusters contained within a housing, the housing containing a leading edge, a trailing edge, a upper surface and a lower surface; wherein the housing includes one or more airflow manipulation devices provided on or associated with the housing configured to manage the airflow into or through at least one of the one or more lifting thrusters.

In other aspects, the invention embraces an aircraft wing including a lift thruster system as defined above, and also an aircraft comprising such a lift thruster system. In the illustrated embodiments, the diameter of each thruster, or rotor is relatively small in percentage of overall aircraft wingspan ratio and the resulting disk load that each carries. The disk loading is a result of the amount of overall rotor area(s) combined that are supporting the aircraft's gross weight. Comparatively, typical rotorcraft design airframes, i.e. helicopter, realize an approximate disk loading of as little as just under 3 pounds per square foot for light utility helicopters to 15 pounds per square foot for heavy lift type helicopters, and to include a high of almost twice that for the V-22 Osprey tilt-rotor airframe at roughly 27 pounds per square foot. These disk loadings while producing highly efficient hover equations suffer from greatly reduced forward flight characteristics. The disk loading of embodiments of the present invention is in excess of 100 pounds per square foot. While these very high disk load (VHDL) rotor systems are comparably less efficient during hover operations, they in-turn offer significant advantages due to the nature of the aerodynamics at work.

In embodiments of the invention, the disk loading of the rotor system may be at least 27 pounds per square foot, but is typically at least 50-75 ppsf, and preferably greater than 100 ppsf.

Herein, the term lifting rotors should be interpreted to cover any arrangement of rotational lift engine, such as pitchable propeller/fan blades, or a gas turbine for example. However, it is envisaged that other types of lift arrangements may be used and so the term lifting rotor should be interpreted as synonymous with ‘thruster’ in that simply some means is required to generate upward lift. Such a lifting rotor system could be incorporated into the wing or body of an aircraft during manufacture and either be an identifiable and discrete component, or be integrated substantially seamlessly into its respective wing. That is, the wing of the aircraft could embody the housing. However, it is also conceivable that the lift rotor system could be integrated as a retrofit option on existing aircraft wings.

In the illustrated embodiment, and currently preferred, is for the housing to contain more than one lifting thruster, for example a pair of lifting thrusters arranged in a row that may be aligned in a fore-aft direction of the housing and, thus, also of the aircraft, when considered in the normal forward flight direction of the aircraft. In one embodiment, the lift rotors/thrusters are aligned in fore and aft position in a tandem arrangement, one behind the other, and their thrust axes are also aligned so as to be mutually parallel.

More lifting thrusters could be provided, for example between three and eight lifting thrusters.

The housing may include or define upper and lower surfaces corresponding to upper (suction) and lower (pressure) sides of an associated wing, respectively. Further, the housing may be elongate, having a major axis aligned with and generally parallel to the major axis of the aircraft's fuselage, and thereby defining a leading edge and a trailing edge. In such a case, the leading edge would be located next to one of the thrusters, that is the fore- or forward thruster, and the trailing edge would be located next to the other one of the thrusters, that is, the rear or aft thruster. The housing may define an intake and an outlet for each of the thrusters. Therefore, the thruster or rotor, as appropriate would be housed by a duct extending between the respective intake opening and outlet opening.

As used here, the term ‘lift thruster (or rotor) system” refers to at least one of the rotor housings and incorporated components.

The one or more airflow manipulation devices may comprise a spoiler located about an intake of at least one of the lifting thrusters. In this way the spoiler serves to purposely disrupt laminar flow accelerating over and into the intake. This is particularly beneficial in the context of the intakes of the forward thrusters, as the use of the spoilers ameliorates the temporary exaggerated lifting force that acts to pitch the nose of the aircraft upwards when transitioning between flight modes

In one embodiment the spoiler may be located on, in the sense of being near to, adjacent, or in the vicinity of, the a leading edge of the housing.

In one embodiment, the spoiler is deployable between a stowed state and a deployed state in which it extends at an angle to a surrounding surface of the housing. In order to minimize the impact on airflow when the spoiler is in the stowed position, in this position the spoiler may be configured to lie flush with the surrounding surface of the housing.

In other embodiments, the airflow manipulation devices include one or more vortex generators located about an intake of at least one of the lifting thrusters. The vortex generators may be arranged singly, in discrete positions around the intake, and as needed so as to provide the optimum manipulation of the airflow. In some embodiment, they may be arranged or grouped into at least one pair of vortex generators, in that two vortex generators are closer to one another that their respective next closest neighbours.

In some embodiments, the pairs grouping of vortex generators may be arranged in a V-shape, for example where the vertex formed by said pair points towards a leading edge of the housing. In some embodiments the vortex generators are static, but in other, they may be deployable between deployed and stowed positions. Beneficially, the vortex generators provide disruption of laminar flow, thereby helping to prevent flow separation, particularly over the leading edges of the rotor housings. As a consequence, this promotes a straighter flow stream over the rotor ducts rearwards, in effect “passing” some of the flow beyond the rotor duct inlet areas.

In other embodiments, the airflow manipulation devices may include a closure arrangement to selectively close or open at least one of the respective intake or outlet of one or both of the first and second thrusters. In overview, the closure arrangement may be in the form of a deployable door that is slidable over the respective intake or outlet or, in other embodiments, may be pivotable elements such as a louver.

The deployable door may comprise a flexible sheet that is deployable from a powered spool, or, in other embodiments, there may be an actuator connected to a free end of the door to pull the door into a closed position and to push the door back into a retracted/stowed position. The deployable door may be activated by a pilot control, or even by a remote controlled operator, but it is envisaged that the deployable doors would likely be operated automatically by a suitable control system, for example during transition between different flight modes.

Although in the illustrated embodiment the deployable door is located at the intake of at least one of the thrusters, the outlets of the thrusters may also comprise a deployable door.

Alternatively the closure arrangement may include a louver system, which may be most appropriate to position on at least one of the outlets of the thrusters, particularly as the louver elements may pivot away from the outlet to the open position and so will be energy efficient to operate.

Beneficially, the closure arrangement is operable to close off the intake and/or outlet openings, so serve to minimize aerodynamic drag during flight. However, they may also provide protection for the rotors when not operating, by providing a physical cover against foreign object damage.

In other embodiments, the airflow manipulation device may include an air curtain system arranged about a respective intake of at least one of the thrusters. The air curtain system may comprise openings, ports, or jet passages arranged to inject or delivery pressurized air into the boundary layer travelling over the upper surface of the rotor housing during flight. The air blast will cut off and/or also extend boundary layer laminar flows over and or around said intake openings in order to manipulate the boundary layer air streams in such a way as to decrease the overall parasitic drag of each lift rotor housing. They may also benefit an overall manipulation of the cruise speed related boundary layer air streams.

The air curtain system may comprise one or more ports extending about a respective intake of at least one of the thrusters. In one embodiment, the one or more slots includes a first port extending forward of one of the thrusters and adjacent a leading edge of the housing, and thus be in the shape of an elongate slot. The slot may instead be an array of discrete ports.

The first slot/port may extend laterally across the housing in a width direction for a length that is about the same as the diameter of the intake of the respective thruster. Alternatively, the slot may be wider than the intake diameter. In this way, the air blast affects the airstream across substantially entire width of the intake. In one embodiment the slot is non-linear in plan view so as to define a forward portion. In other words, the slot forms a shallow V-or arrow head shape, which may point towards the leading edge of the housing.

As discussed above, where systems are required for operating the airflow manipulation devices, it is considered that such systems would be straightforward to implement for persons of teams of such people conversant and skilled in the field of aeronautical flight control systems based on existing hardware including suitable hardware, software and firmware, as appropriate, that is configured, tested, and accepted for use in aeronautical flight control systems.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described in more detail with reference to the accompanying drawings, which are listed below. It should be noted that some geometry depicting the various embodiments described herein as well as the respective actuators of said devices are not illustrated to scale and/or are shown in exaggerated positions to aid understanding

FIG. 1 is a perspective view of an example of a type of aircraft in which embodiments of the invention may be incorporated;

FIG. 2 is a perspective view, for completeness, of a rotor drive train system of the aircraft shown in FIG. 1;

FIG. 3 is a perspective view of a portion of an aircraft/airframe, similar to that in FIG. 1, illustrating an embodiment of the invention;

FIG. 4 is a top view of the aircraft design in FIG. 1;

FIG. 5 is a perspective view of a wing portion of an aircraft like that in FIG. 1, illustrating another embodiment of the invention featuring a deployable spoiler;

FIG. 6 is a view from above of the wing portion in FIG. 5, whereas FIGS. 7 and 8 are section views along the line B-B illustrating the deployable spoiler in two different operating positions or states, respectively;

FIG. 9 is a perspective view of a rotor housing in accordance with another embodiment of the invention, and FIG. 10 is a top view of FIG. 9;

FIG. 11 is a perspective view of a forward portion of lift rotor housing showing an example of physically closing an upper mouth or opening of a rotor housing via a high-speed shutter material and linear actuator mechanism, as also shown in FIGS. 3 and 4;

FIG. 12 is a section cutaway view along the line A-A in FIG. 4, this forward portion of the rotor housing showing an example of the high-speed shutter mechanism with its linear actuator extended and with the shutter being in the open position, whereas FIG. 13 shows the shutter arrangement being in the closed position;

FIG. 14 is a perspective view looking up at the underside of a forward portion of rotor housing, for example of the aircraft of FIG. 1, illustrating a further shutter arrangement in accordance with another embodiment of the invention. This view shows the shutter arrangement in an open position;

FIG. 15 is a section cutaway view of the rotor housing in FIG. 14, which shows the shutter arrangement in more detail, whereas FIG. 16 shows the shutter arrangement in a closed position;

FIG. 17 is a perspective view of a forward portion of lift rotor housing with integrated air curtain openings in accordance with a further alternative embodiment of the invention;

FIG. 18 is a top view of the rotor housing in FIG. 17 incorporated into a wing of an aircraft, and also depicts the air feed tubes that would supply said air curtain openings/bleed air ports;

FIG. 19 is a section view of an example rotor mount/housing portion on this aircraft's enclosed lifting rotor system. It generally depicts the basic gross slipstream behavior that will occur by simply sealing the rotor holes with the still spinning, but with zero-angle collective pitch setting.

FIG. 20 is a section view of an example rotor mount/housing portion on this aircraft's enclosed lifting rotor system. This diagram generally depicts the basic gross slipstream behavior that will occur by differentially pressurizing the front to back rotor holes in a way that would trim or pitch the nose down.

FIG. 21 is a section view of an example rotor mount/housing portion on this aircraft's enclosed lifting rotor system. This diagram generally depicts the basic gross slipstream behavior that will occur by differentially pressurizing the front to back rotor holes in a way that would trim or pitch the nose up

### DETAILED DESCRIPTION

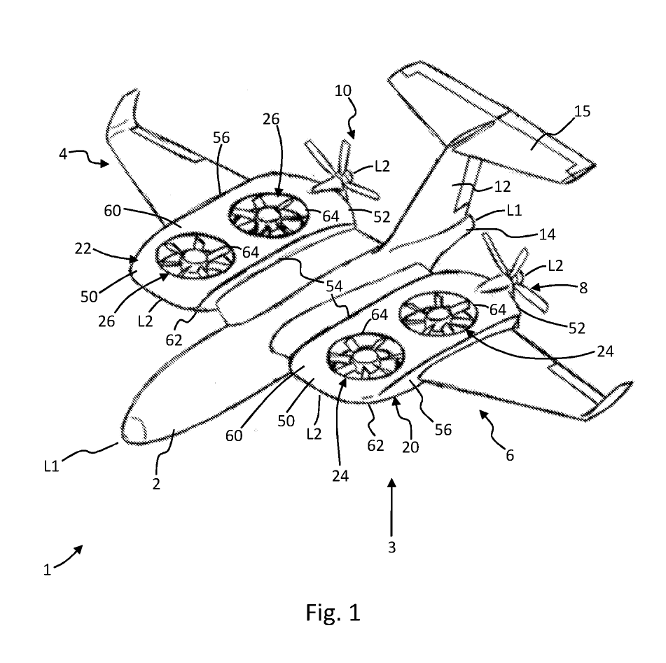

With reference firstly to FIG. 1, there is shown a VTOL aircraft as an example of the type of aircraft into which the embodiments of the invention may be incorporated. The VTOL Aircraft 1 comprises of a main fuselage 2, disposed centrally, a right main wing section 4 and a left wing section 6. The left main wing section 6 mounts onto and/or is extended from the left side of the main fuselage, and the right wing 4 as well, mounts onto and/or is extended from the right side of the main fuselage 2.

A horizontal stabilizer 12 extends upwardly from a tail section 14 (or empennage) of the main fuselage 2 and terminates at a laterally extending vertical stabilizer 15 forming what is largely known in the art as a “T-Tail” assembly comprising of both horizontal and vertical stabilizing and control surfaces. It should be noted that this is just an example and other tail configurations are applicable such as twin-booms, mid-mounted vertical stabilizers, V-tail assembly, for example. Suitable control surfaces such as elevators, rudders and ailerons and flaps are provided on the vertical stabilizer, the horizontal stabilizer and the wind sections, as appropriate and in the usual way to provide in-flight attitude and lift control for the aircraft.

Two forward thrusters are provided: a left side thruster 8, and right side thruster 10, which are arranged so as to be parallel to the primary longitudinal axis L1 of the aircraft. The thrusters are shown here as open propellers, but may also be other configurations such as gas turbines, turboprops or inducted fans, for example. Various options exist for mounting the thrusters to the airframe, for example they may be mounted on the flanks of the empennage section. However, in the illustrated embodiment they are mounted on respective lift rotor housings that are integrated into the left and right main wing sections.

The aircraft includes a lift rotor system 3. Mounted to the left main wing section 6 is a left lift rotor housing 20, and mounted to the right main wing 4 is a right lift rotor housing 22. The left lift rotor housing 20 encompasses and retains at least two preferably collective pitch lifting rotor assemblies 24, and the right lift rotor housing 22 also encompasses and retains at least two preferably collective pitch lifting rotor assemblies 26.

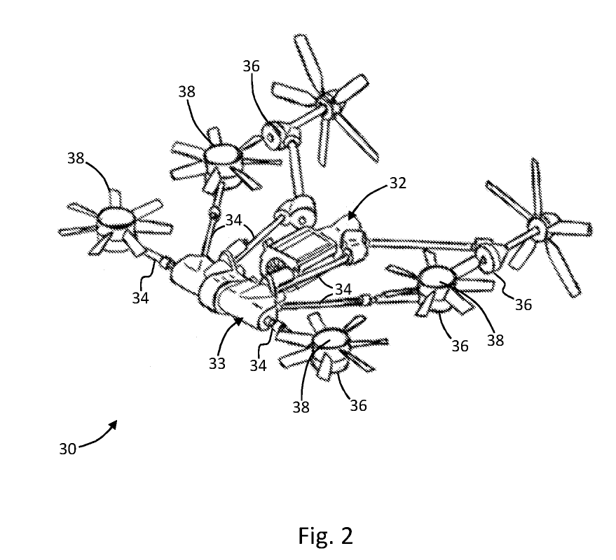

All of said thrusters and lifting rotors are powered, and/or driven, and rotate via a central drive and transmission system 30, commonly known in the art as a combining gearbox—this is shown in FIG. 2. The drive system 30 is mounted centrally in the main fuselage 2, and incorporates at least one engine/turbine 32 which transfers torque through a main gearbox 33, subsequent drive shafting 34 and ancillary gear boxes 36 at or near each individual rotor assembly 38. In alternative embodiments, it is envisaged that a hybrid fuel engine driven electric generation system may power specific electric drive motors located and likely alternatively mounting each respective rotor assembly that they are driving. The fuel engine would drive a generator that will in turn charge and maintain the power level of a main battery storage bank which then in turn powers said electric motors at each rotor location. The battery bank will also serve as boost power source when extra torque is needed during what is known in the art as “hot and high” hover and or flight operations, or other like situations that may require extra torque to be delivered to said system.

The following discussion provides an overview of the operational capabilities of the aircraft to provide the reader with an overview of how the aircraft would function.

Hover flight attitude of the aircraft in FIGS. 1 and 2 is controlled via conventional type physical pilot interface controls (not shown), i.e. typical hand yoke or centre stick controls for pitch and roll attitudes, rudder pedals for yaw axis control, and throttle and pitch control levers or knobs alike to control the thruster forces and or pitch settings, and a collective control, the collective lifting rotor pitches, where the overall lift of the at least four total lifting rotors is controlled via one lever/knob. As a whole, the onboard flight control system is known as a “fly by wire” system, as is well established in the art, whereby inputs from the physical pilot controls as described above, are sensed by a main central flight processor (CFP) which is not shown, that in-turn drives the respective control surfaces, the various lift rotor and or propeller collective pitch mechanisms, and the engines all via servo motors specifically calibrated to actuate each. Further, within the CFP may be an enhanced internal measurement unit coupled to a redundant sensor array that is altogether called the Stability Augmentation System (SAS). This comprehensive SAS (not shown) comprises multiple (and redundant) gyroscopes, accelerometers, temperature, barometric, and as well as linear sensors that all work together between the pilot and the actual flight control surfaces, propellers, rotors, and engines to provide various intermediate control inputs in order to greatly reduce the pilot's work load, particularly during flight operations in more adverse conditions. The pilot has full authority of the control input, but as he or she holds said controls steady, the CFP/SAS takes care of the finite and maintaining control adjustments that keep the aircraft in the intended attitude and orientation during hover operations. This may be thought of or described as an autopilot function for hovering, and is a common technique employed in contemporary vertical lift aircraft having an electronic flight control system.

The control system for the aircraft may implement selectable flight modes and also the CFP/SAS has the ability to discern appropriate flight mode selection depending on aircraft speed, altitude, and orientation. During hover mode operations, when the pilot moves the control yoke or stick forward, the aircraft moves forward and maintains a level pitch and roll axis attitude. When the pilot pulls back on the stick in hover mode, the aircraft moves rearward which again maintaining level pitch and roll axis attitudes. If the forward and indeed reversible thrusters are somehow disabled or inoperative, or further by specific pilot choice, an alternative hover control mode is automatically or selectively activated whereby the aircraft pitch and roll axis attitudes are effectively manipulated in order to manoeuver the aircraft in hover.

When the pilot moves the control yoke or stick forward in this alternate hover flight mode the collective pitch of the at least two rearward lift rotors is slightly increased while the collective pitch of the at least two forward lifting rotors is slightly and simultaneously decreased which acts upon the center of gravity (CG) of the aircraft to lower the nose and to enact differential forces that result in a forward aircraft motion. This is similar to a helicopter pilot cyclically tipping its main rotor forward with its respective control stick thereby causing its fuselage to nose down while moving the helicopter forward as well. When the pilot moves the control yoke or stick rearward in the aircraft in this alternate hover flight mode the collective pitch of the at least two rearward lift rotors is slightly decreased while the collective pitch of the at least two forward lifting rotors is slightly and simultaneously increased which acts upon the C of G of the aircraft to raise the nose and to enact differential forces that result in a rearward aircraft motion. It is to be noted as well, that in this alternative hover flight mode, a forward flight speed of at least one third of the aircraft's normal cruise velocity can be achieved by pitching the nose down as described just above and subsequently controlling the aircraft attitude via its normal aerodynamic surfaces. This is an effective backup and potential safety procedure that a pilot can employ should the main thrusters be disabled or somehow become inoperative.

Augmenting the control and stability of the aircraft during take-off and landing operations can be achieved with said CFP/SAS. Stability augmentation may be provided while a pilot converts flight modes between hover operations and forward, wing-born flight during take-off. The CFP/SAS will handle said conversion and flight mode changes providing redundancy and added safety to these operations. Likewise, during a landing operation, the CFP/SAS will automatically convert the aircraft between normal forward flight and vertical landing flight modes.

Returning to aircraft attitude control during normal hover operations: when the pilot rotates the control yoke clockwise or moves the control stick to the right, the collective pitch of the at least two left side lifting rotors is slightly increased while the collective pitch of the at least two right side lifting rotors is slightly and simultaneously decreased which acts upon the CG and roll axis of the aircraft to lower the right wing and raise the left side wing generating differential forces that result in the aircraft moving sideways toward the right. When the pilot rotates the control yoke counter-clockwise or moves the control stick to the left, the collective pitch of the at least two left side lifting rotors is slightly decreased while the collective pitch of the at least two right side lifting rotors is slightly and simultaneously increased which acts upon the CG and longitudinal roll axis of the aircraft to raise the right wing and lower the left side wing enacting differential forces that result in the aircraft moving sideways toward the left.

To effect purposeful rotation or anti-rotation control about the aircraft's yaw axis the pilot will use the conventional rudder pedals at the feet of the pilot. To turn or yaw the aircraft to the right, the pilot depresses the right pedal into the floor toward the front of the aircraft and the left pedal comes back toward the pilot given the usual expected push-pull bell- crank mechanism action that is employed in these systems. To turn or yaw the aircraft to the left, the pilot depresses the left pedal into the floor toward the front of the aircraft and the right pedal comes back toward the pilot given the usual expected push-pull bell-crank mechanism action that is employed in such systems conventionally.

In hover modes, the yaw attitude, or aircraft heading (compass direction), is maintained by the CFP/SAS by default. However, the pilot can turn and point the aircraft at will, and once the rudder pedals are released again the CFP/SAS immediately maintains the new heading. Various techniques may be used to yaw the aircraft. Primarily, the yaw control may come from the differential control of the at least two thrusters. Yawing commands to rotate the aircraft to the right, involve slightly increasing thrust from the left thruster while decreasing thrust or even reversing thrust from the right thruster. Yawing commands to rotate the aircraft to the left involve slightly increasing thrust from the right thruster while decreasing thrust or even reversing thrust from the left thruster.

Secondarily, yaw control may be achieved and or enhanced by the CFP/SAS creating an unbalanced rotational torque force between opposite spinning lift rotor pairs; either by increasing collective pitch of opposite diagonally oriented rotor pairs and decreasing the collective pitch of the 90 degree axis relative pair, or by simply increasing the RPM of said first pair and decreasing the RPM of the 90 degree axis relative pair alike.

Thirdly, yaw control may be enhanced by use of the ancillary nose or rear mounted controllable rotors (not shown) that may be oriented to produce turning forces toward the sides of its mounted position. This force moment would act upon the CG of the aircraft to cause a yaw rotation about its vertical axis, functioning much like a helicopter tail rotor does to counter the torque force of its main rotor and or sideways wind forces.

Further, the CFP/SAS may be operable to maintain the position, heading, and altitude of the aircraft by default in the hover modes. The pilot can disengage this automatic attitude control manually if necessary or if desired. As part of an enhanced CFP/SAS feature, the aircraft has a plethora of forward and back, as well as side to side proximity sensors that serve to feed collision avoidance warnings and feedback to the pilot and the system itself. Once again, by default, the system will not allow the aircraft to come into contact with obstacles in its surroundings. This too, may be adjusted or even disabled if desired or necessary. Finally, the CFP/SAS system itself can (auto) pilot the aircraft completely autonomously. The system will be used in sub-scale versions of the aircraft designed to serve as unmanned aerial vehicles (UAVs), to be used for many mission sets that already exist, and to improve and even open many more types of applications offering unmatched controllability and safety to UAV operations.

Forward/Cruise flight attitude of VTOL Aircraft 1 (FIG. 1) is controlled via the same conventional type physical pilot interface controls (not shown), mentioned above. Again i.e. typical hand yoke or centre stick controls for pitch and roll attitudes, rudder pedals for yaw axis control, and throttle and pitch control levers or knobs alike to control the thruster forces and or pitch settings.

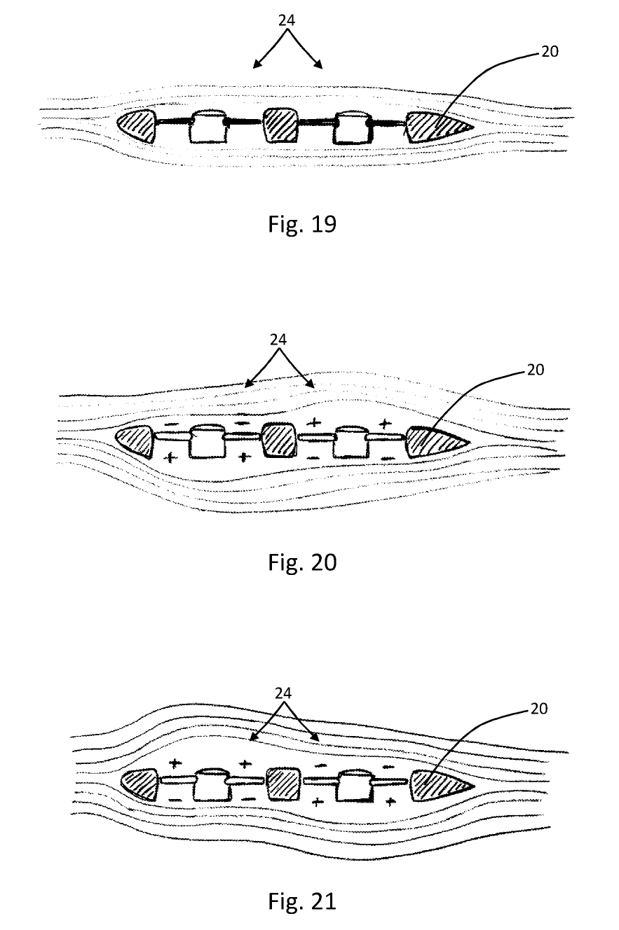

FIGS. 19, 20 and 21 provide further insight into the behavior of the lifting rotors. FIG. 19 is a section view of an example rotor mount/housing portion on this aircraft's enclosed lifting rotor system and depicts the basic gross slipstream behaviour that will occur by simply sealing the rotor holes with the still spinning, but with zero-angle collective pitch setting. FIG. 20 is a section view of an example rotor mount/housing portion on this aircraft's enclosed lifting rotor system and depicts the basic gross slipstream behaviour that will occur by differentially pressurizing the front to back rotor holes in a way that would trim or pitch the nose down. FIG. 21 is a section view of an example rotor mount/housing portion on this aircraft's enclosed lifting rotor system and depicts the basic gross slipstream behaviour that will occur by differentially pressurizing the front to back rotor holes in a way that would trim or pitch the nose up.

Once the pilot/CFP/SAS converts the aircraft to cruise flight mode, the lifting rotor collective pitches may be lowered or reduced to a zero pitch blade angle setting so as to nearly eliminate the power draw on the overall drive train (FIG. 19). The rotors remain spinning but under nominally no load to the system at zero pitch. This serves to aerodynamically seal their hole through the housing wing section.

At cruise flight speeds then the collective and or individual collective pitches of the lift rotors are automatically slightly adjusted or manipulated by the CFP/SAS, thereby causing differential pressure zones in/at each rotor hole area, which in turn changes the slip stream airflows flowing over and under these areas, so as to move the aircraft's effective aerodynamic centre of lift by the resulting boundary layer air manipulation. This is enacted by said differential pressures in each rotor hole being created by the differing pitch settings (as shown in FIG. 20 and FIG. 21). This causes the resultant effective shape change of this section of the wings in cruise flight, thus moving the effective aerodynamic centre of lift of these sections, which finally results in a further reduced drag condition to improve the aircraft performance.

The above discussion provides an overview of a type of VTOL VHDL aircraft into which the embodiments of the invention may be incorporated. Other configurations would be possible, however, and so the invention should be considered with this in mind. Notably, in the illustrated aircraft, the lift rotor housings 20,22 of the aircraft, which contain the fore and aft lift rotors/thrusters 24,26, protrude or stand proud of the remaining surface area of the wing. However, in other embodiments the rotor housings may be integrated into the wind in which case the outer surface of the rotor housings may blend seamlessly with the inboard and outboard wing sections.

A challenge associated with the type of aircraft described above is to manage effectively the high speed airflow into and around the lift rotor housings so as to optimize the performance of the aircraft during various flight modes, for example during hovering, forward flight, and transition between these modes.

Referring to the drawings included herein and as briefly described above: The present invention utilizes known aerodynamic lift enhancing and wing lift control devices to manipulate the boundary layer air flow over and around the rotor housings 20,22 of a very-high-disk-load (VHDL), fixed-wing (FW), vertical take-off and landing (VTOL) aircraft (1, FIG. 1).

As will be appreciated in FIG. 1, each of the lift rotor housings 20,22 is a noticeable part of the wing as it protrudes from and stands proud of the wing. Each lift rotor housing 20,22 is generally rectangular in shape. Although the rotor housings are visually distinct from the surrounding area of the wings, it should be appreciated that each rotor housing defines a general airfoil or at least aerodynamic, cross section along their major axis L2, running from front to back, when considered in the normal direction of forward travel. Although the longitudinal cross section of the rotor housings need not generate lift, it is preferable that their shape be generally aerodynamic so that they minimize drag in forward flight.

By virtue of its shape, and its orientation on the wing, each rotor housing can be considered to have a leading edge 50 and a trailing edge 52, which considered in the direction of normal forward flight. The leading edge 50 of the rotor housing is alongside the leading edge of the associated wing, and, conversely, the trailing edge 52 is alongside the trailing edge of the associated wing. Note than in the illustrated embodiment, the forward thrusters 8, 10 extends rearwards from the trailing edges 50,52 of the rotor housing, although in other embodiments the forward thrusters may be mounted in different positions on the aircraft.

Extending between the leading edge 50 and trailing edge 52, the rotor housing 20/22 defines inboard and outboard side edges 54,56 respectively. In the illustrated embodiment, the side edges 54,56 are distinct from the adjacent parts of the wing within which the rotor housings are incorporated, although it should be noted that in embodiments where the rotor housings form a less distinguishable part of the wing, the side edges would likely merge with the adjacent parts of the wing.

The rotor housings also define an upper surface 60 and a lower surface 62. The upper surface is on the same side as the suction side of the wing (due to the higher airflow on this side of the wing) and the lower surface 62 is on the same side as the pressure side of the wing.

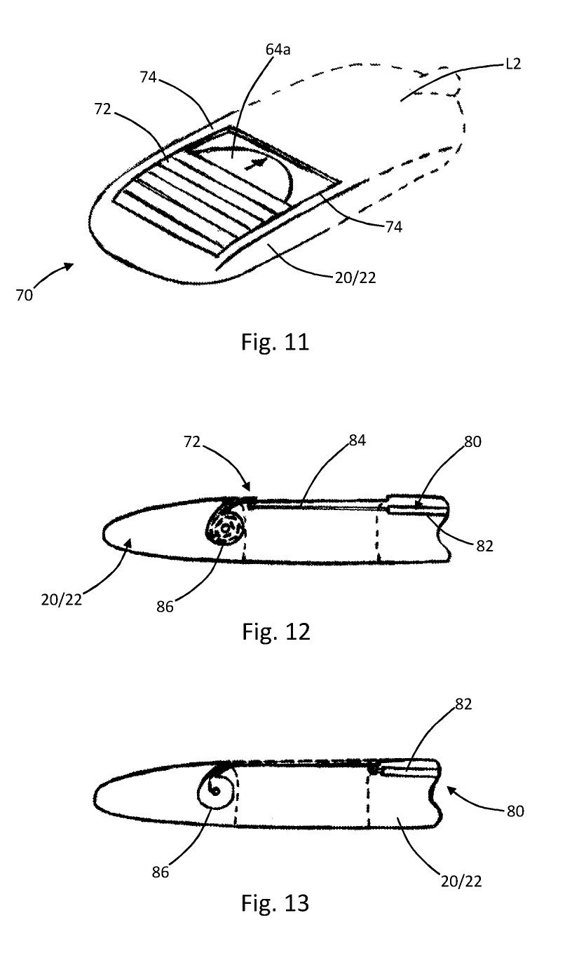

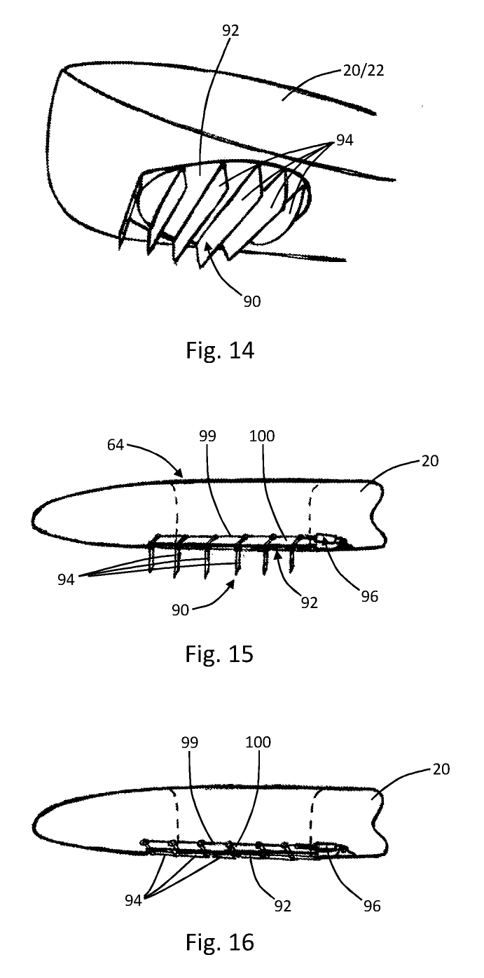

As can be seen the rotors/thrusters 24,26 are located within the rotor housings and so define respective intakes 64 and outlets 66 so that air can flow to the rotors through the intake, through the rotor housing via respective rotor ducts than extend between the intake and outlet, and then out of the rotor through the outlet. Note that the outlets 66 are shown in FIG. 14, which is a view of the underside of the rotor housing. Also note that the ducts 65 are best appreciated by FIGS. 12 and 13 for example.

Here, the intake is depicted by the circular opening in the upper surface 60 of the rotor housing 20,22, but in fact can be considered extend somewhat beyond the circular opening to the surrounding part of the upper surface 60. In practice, the rotor housing would is shaped so that its upper surface presents a smooth surface that curves radially inwards into the rotor housing so as to present an optimal surface for airflow to minimize flow separation and turbulence.

Having described the general layout of the rotor housings 20,22, the following description will focus on several different devices for managing and controlling the airflow into, through and out of the rotor housings and their respective rotor intakes and outlets. Collectively, these devices will be referred to as airflow manipulation devices.

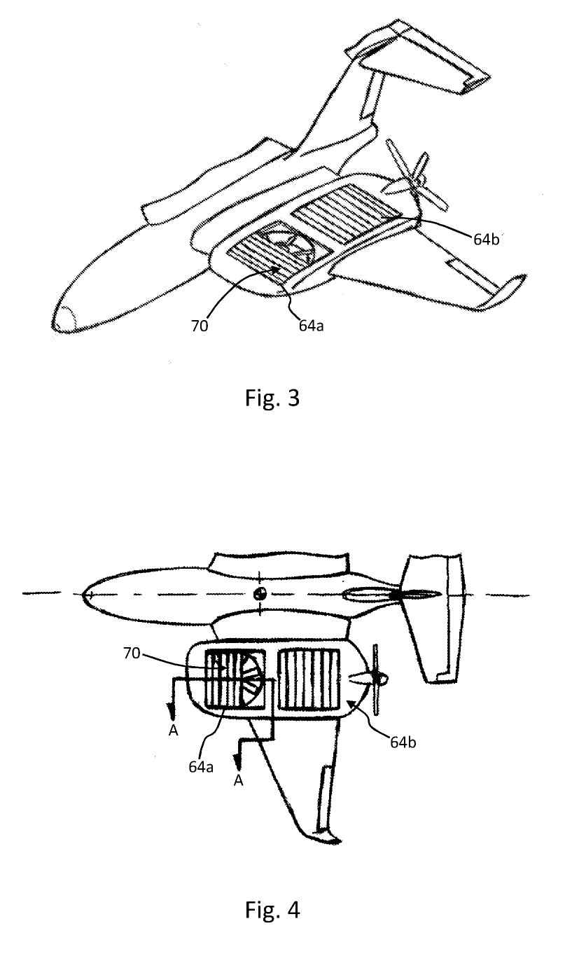

A first example of an airflow manipulation device, or arrangement, according to an embodiment of the invention, is shown in FIGS. 3, 4, 11 to 13. Here, the airflow manipulation device is a closure arrangement 70 to selectively close or open at least one of the respective intake or outlet of one of both of the rotor housings. In the illustrated embodiment, the closure arrangement 70 takes the form of a deployable door or shutter that is slidable over the open area of the intake so as to restrict the airflow into the rotor. The deployable doors are controllable independently so as to be able to vary individually the airflow into the forward and rear rotors. The deployable door is shown as fully closed on the rear intake 64b and is shown as partially open on the forward intake 64a. Beneficially, the deployable doors enable optimization of the cross sectional wing chord shape of the lift rotor housings of said aircraft for the cruise flight regime, and add separated and differing open areas for the intakes to physically inhibit any flow streams from entering the rotor housing openings/intakes.

FIG. 11 shows an example of a directional high speed door or shutter 72 that could be being used to close to upper housing opening area or intake 64a. The door 72 may be mounted on parallel rails 74 that enable the door to deploy and retract along the rails in a fore-aft direction, that is, along the major axis of the rotor housing. A suitable bearing surface such as roller bearing or other low-friction medium could be provided to ensure that the door slides freely and reliably without obstruction. FIGS. 12 and 13 illustrate the closure arrangement 70 in cross section along the line A-A in FIG. 4, and respectively, illustrate the door in open and closed positions or states.

The deployable door 72 includes a suitable actuation mechanism to enable it to be opened and closed rapidly. In one embodiment, the actuation mechanism would be operable to deploy the door to a selected position between the fully open and closed states. FIG. 12 is a cutaway view that depicts said actuation mechanism 80. The actuation mechanism 80 may include a pneumatic, hydraulic, or electric linear actuator or ram 82 having a link 84 that grips or otherwise is connected to the free end of the deployable door 72. The deployable door 72 is flexible and, as such, may be made from a plurality of connected elements or slats, or may be a contiguous flexible sheet, for example of a suitable fabric or polymeric material. Here, the deployable door 72 is shown is a stowed position in a spooled configuration on a spool or drum or roll 86. On actuation, the actuator 82 operates to retract the door across the opening/intake 64a towards the closed position, although it may position the door in a partially closed position. FIG. 13 shows the door 72 in a fully closed position.

As an alternative to the actuator 82, the spool 86 may be powered by a suitable motor so that, as the spool is driven to rotate, the door 72 extends along the guide rails 74 and so is configured into the deployed position, i.e. any position that is not fully open.

It is envisaged that the closure arrangement 70 discussed above could also be implemented on the downwardly facing outlets of the rotor housings. However, current thinking is that a more effective solution would be to provide a generally less restrictive closure arrangement to the outlet openings as compared to the intakes/inlets.

One example will now be described with reference to FIGS. 14 to 16. FIG. 14 shows an example of a semi-automated large moment shutter or louver system 90 that could be employed to close off the lower surface openings/outlets 92 in said rotor housing 20/22. The louver system 90 comprises a plurality of shutter elements 94 in the form of slats which extend across the open area of the outlet 92 and are operable between closed positions in which they lie flat against the rotor housing 20/22 and open position in which they pivot away from the rotor housings, preferably but not necessarily perpendicularly, so as to present minimal disruption to the airflow through the outlet.

FIG. 15 is a cutaway side view of the lower rotor opening/outlet 92 showing the louver system 90 in the rotor housing 20. Here, the louver system 90 is held in the open position by its control mechanism 96 comprising, in this embodiment, a short throw linear actuator 98, and a linkage system 99 that interconnects said louver elements 94 by separate levers 100. The linear actuator 98 is extended here, holding the louver elements 94 in the open position. FIG. 16 shows said louver system in the closed position with the linear actuator 98 in extended position.

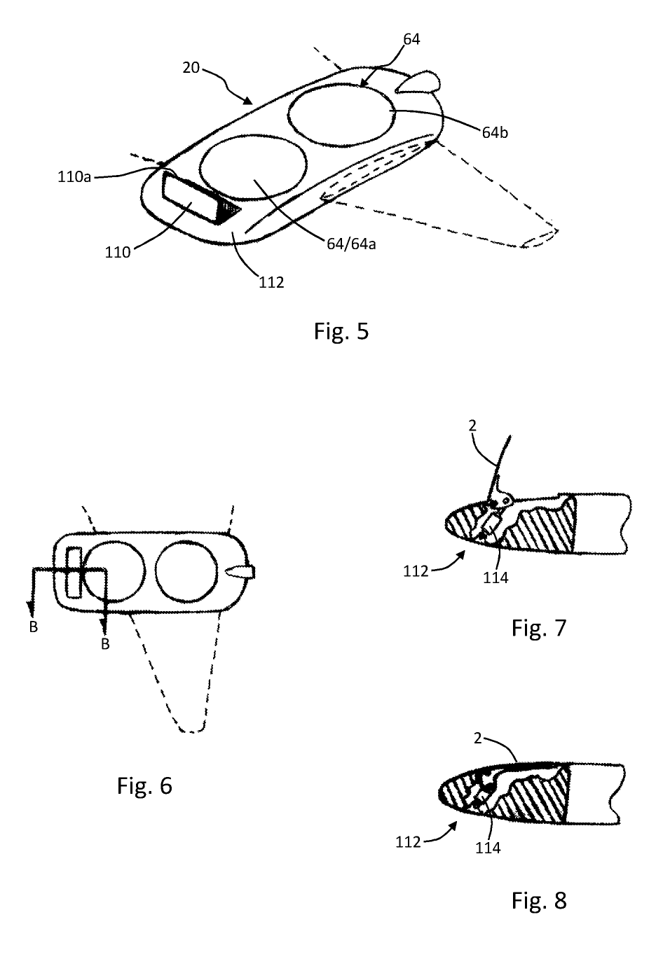

Another example of an airflow manipulation device that would provide significant advantages in the type of VTOL VHDL aircraft described above, will now be described with reference to FIGS. 5 to 8.

Referring firstly to FIG. 5, the rotor housing 20 is provided with a spoiler 110 located about the intake of at least one of the thrusters/rotors. The spoiler 110 is deployable or extendable between stowed and deployed positions, and in FIG. 5 it is shown in a fully deployed position in which it extends at an angle to the surrounding surface of the rotor housing 20. In general, it may extend to a variable angle, up to perpendicular to its adjacent surface of the rotor housing. In other embodiments the spoiler may be in the form of a wall of fence which may project straight upwards form the rotor housing by a predetermined distance.

The spoiler 110 is defined by a generally rectangular, and generally planar, surface that forms part of the surface of the rotor housing but is pivotable away from that surface into the deployed position. It is envisaged that the spoiler would be infinitely deployable, in that it would be able to adopt any number of deployed positions between fully stowed and fully deployed.

In the illustrated embodiment, the spoiler 110 is located at the forward inlet rim area 112 of the forward lift rotor housing opening/intake 64. In this way the spoiler 110 as shown in FIG. 5 is used to purposely disrupt laminar flow accelerating over and into the intake thereby mitigating a large pitch up moment that would be caused from the super accelerated airflow into that rotor housing opening 64. Notably, a long edge 110a of the spoiler 110 has a length that extends across substantially the entire width of the rotor housing intake 64, which optimizes the flow disruptive effect.

Although in the illustrated embodiment a single spoiler 110 is shown located in front of the forward rotor intake 64a, it is envisaged that a further spoiler may be provided in front of the rear rotor housing intake 64b, although this option is not currently preferred since the main technical issue is the forward rotor ducts sometimes causing a temporary exaggerated lifting force that acts to pitch the nose of the aircraft upwards when transitioning between flight modes. In a sense, one effect of this is to force an air stream to enter the rear rotor intakes/ducts which could benefit the aircraft during flight mode transitions by equalizing or at least to some extent counteracting the pitching moment caused by the forward rotors. In summary, blocking or stalling the airstream entering the forward rotor ducts reduces the pitch-up effect and, combined with pitch control of the rear rotors and suitable control input to the conventional aircraft control surfaces, improves the handling of the aircraft.

Currently, it is envisaged that the spoiler will be deployed on a temporary or short-burst basis when the control system anticipates that a pitch-up moment is experienced or likely.

FIGS. 7 and 8 are simplified section cutaway views along the line B-B in FIG. 6 and illustrate a typical operation mechanism 112 of such a spoiler 110. In overview, the spoiler 110 may be operated much like a conventional aerodynamic control surface, flap, aileron of a typical aircraft. In the illustrated embodiment, the operation mechanism 112 includes a short-throw linear actuator 114, which may be hydraulic, pneumatic, or electrically actuated, for example. In this view the actuator 114 is extended as it holds the spoiler 110 in its also extended position so to effect the desired airflow disruption as described. FIG. 8, conversely, shows the linear actuator 114 in its retracted position, which in turn retracts and secures the spoiler 110 in its retracted or stowed position so that it sits flush and so merges with the surrounding outer surface of the rotor housing.

It is envisaged that in some circumstances the spoiler 110 may be used in conjunction with the closure arrangement 70 as described in the embodiments above, and shown in FIGS. 3 and 4, for example.

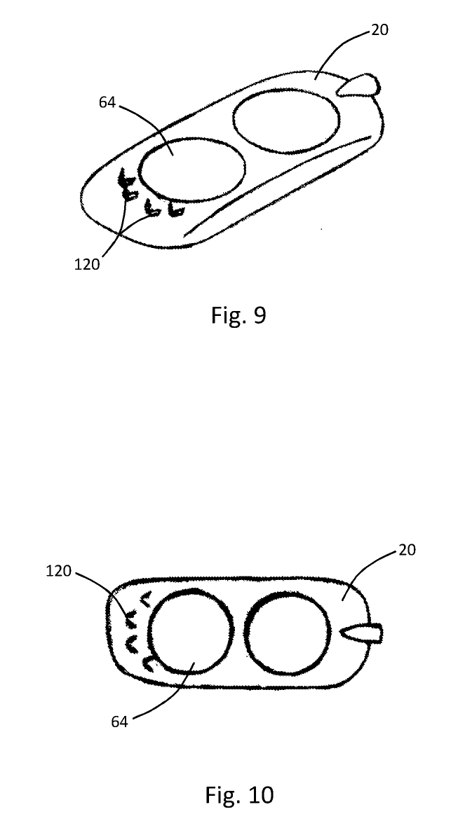

A further enhancement to the rotor housing 20 will now be described with reference to FIGS. 9 and 10. In this embodiment, the airflow manipulation devices are provided by one or more vortex generators 120. The vortex generators 120 may be located about at least one of the intakes of the rotor housing 20. In this particular embodiment, are positioned ahead of around the forward rotor housing inlet areas as per the relative wind direction during forward flight. Four vortex generators 120 are provided, which are arranged to spread across in front of the intake 64 for substantially its entire width, in this embodiment, although a more restricted or ‘shorter’ spread may also be acceptable. This optimizes the flow disruption into the intake 64.

Herein, the term ‘extending about’ should not be interpreted to require an encircling of the rotor intake, but instead that the items in question may be located in one or discrete positions at points around the intake openings, and particularly in a spread configuration extending around a portion of the intake opening, but not necessarily all around it.

Vortex generators having various forms may be provided. In the illustrated embodiment, the vortex generators include short stubs that protrude from the adjacent surface of the rotor housing. Here the vortex generators 120 are grouped into at least one pair, although there are four pairs in this embodiment. In each pair, the two vortex generators 120 are arranged in an arrow or V-shape configuration such that the vertex between each pair points forward towards the leading edge of the rotor housing.

In some embodiments, the vortex generators are configured so that they may be retracted into the rotor housings and, conversely, deployed from the rotor housings.

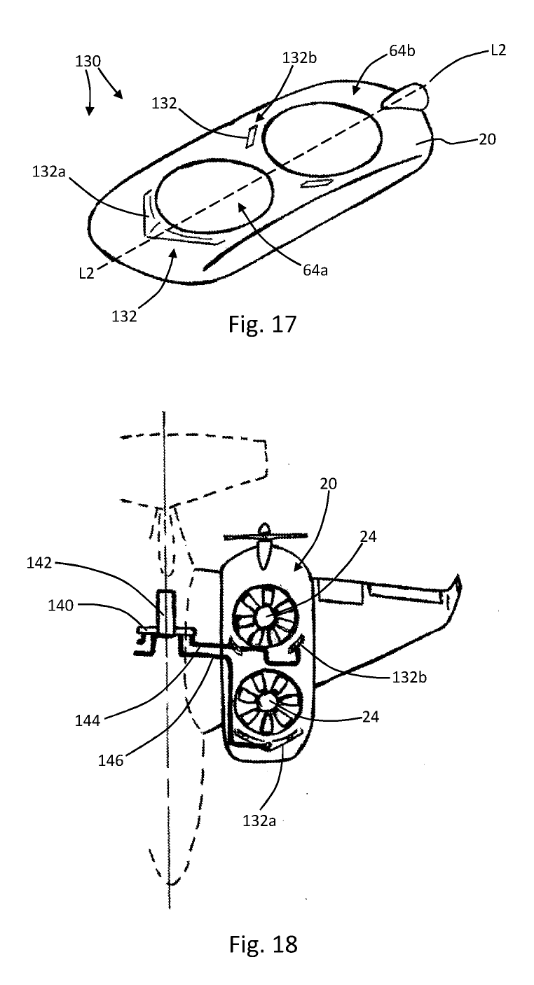

Another performance enhancing technique that may be incorporated into such VHDL VTOL aircraft as discussed above, would be to use bleed air from the main engine compressor or to utilize an ancillary compressor in order to create boundary layer altering air curtains over and about various locations of said lift rotor housings and also their respective rotor openings/intakes. Such a system is illustrated in FIGS. 17 and 18.

With reference to those drawings, the rotor housing 20 includes an air curtain system 130 arranged about a respective intake of at least one of the rotors/thrusters. In the illustrated embodiment, the air curtain system 130 comprises ports in the form of slot-shaped openings 132 that provide an air blast upwardly from the rotor housing 20. As an alternative to slots, it is envisaged that an arrangement of circular holes or ports, for example arranged into a linear pattern such as a row, would also function well. The air blast will cut off and/or also extend boundary layer laminar flows over and or around said intake openings 64 in order to manipulate the boundary layer air streams in such a way as to decrease the overall parasitic drag of each lift rotor housing. They may also benefit an overall manipulation of the cruise speed related boundary layer air streams.

Although the slot openings may in theory be placed at any point around the intake openings 64, it is envisaged that a significant benefit will be achieved by configuring the rotor housings 20 so that the slots are located forward of a respective one of the intake openings. FIG. 17 shown one example of a possible position for the slot openings 132, in which a first slot opening 132a is located in front of the forward intake opening 64a. As can be seen the front slot opening 132a extends across the rotor housing 20 laterally, that is across the major axis L2, and has a length comparable to the diameter of the intake opening 64a.

Although a slot opening having the same configuration could also be located in front of the rear intake opening 64b, here a different configuration is shown. Instead rear intake opening 64b is associated with a pair of second slot openings 132b, each one of the pair flanking a forward part of the intake opening 64b. In this way, the second slot openings 132b act on the inbound airflow coming past the flanks of the forward intake opening 64a.

The slot openings 132a,132b may be fed pressurized fluid/air as follows: bleed air manifolds within the main engine system, within the overall drivetrain or other such manifolds 140 from an ancillary compressor 142 will be connected to the air curtain slot openings 132 via appropriate feed and distribution tubes 144,146 that are routed to their appropriate locations in the rotor housing 20. Ancillary compressors will be driven independently, electrically or via auxiliary drive ports on the main combining gearbox alternatively.

Various modifications may be made to the specific embodiments described above without departing from the inventive concept, as defined in the claims. For example, although the above airflow manipulation devices have been described separately, it should be appreciated that each of them may be appropriately combined. For example, the spoiler 90 may be provided in addition to either or both of the closure arrangement and the lower shutter system In the above embodiments, the rotor housings have been illustrated with a closure arrangement that can selectively limit the aperture or open area of the intake and outlet of the rotor ducts. Although both upper and lower closing system could be provided, it would also be acceptable to provide one or the other. In one embodiment, for example, it may be adequate to only provide the rotor housings with the closures/shutter at the outlets of the rotor ducts, as this may be enough to capture a high pressure region within the rotor duct which would have the effect of limiting the parasitic drag generated by the open upper side of the rotor duct.

However, in other scenarios, it may be beneficial to provide the closure arrangement on the upper rotor openings, not least because such an arrangement will provide some protection against the risk of foreign object damage (FOD) on the rotors. Such an event could occur in hail storms, for example, so suitable protective measures would be desirable.

More generally, it should be noted that the use of any one or all of the above methods, techniques and systems to enhance the aerodynamic performance of an otherwise high parasitic drag plagued lift rotor housing wing section like that associated with the VTOL VHDL aircraft described above, can be combined with the purposeful manipulation of the lifting rotors themselves to enact a change in each of their local housing openings. As FIGS. 19, 20, and 21 show the potentially effected boundary layer air flow stream representations that would result from such individual differential rotor manipulation. Example 1: As shown in FIG. 20, the forward lifting rotor collective pitch setting is set to a slightly higher lift setting from its neutral flat-pitch, no-lift setting. This results in a lower localized pressure (14) above this rotor at its upper housing intake opening, while simultaneously increasing the pressure under the rotor at the lower surface opening. The sum of pressures creates a bubble or bulge effect to occur in the relative wind stream of boundary layer air flow thus altering its ultimate shape at cruise speeds. Typically coinciding with a forward lift rotor being set as described, an accompanying rearward lift rotor would be set to an opposite condition having its collective pitch set to a negative lift mode thereby creating higher localized pressure above its upper rotor housing opening and subsequently lesser localized pressure below its lower rotor housing opening. The result of these differing localized pressure regions in fact then serves to alter the overall boundary layer air streams and thus aerodynamically shape changing the effective airfoil shape during cruise flight speeds. FIG. 21 and FIG. 19 go on to show examples of the reverse, and with neutral rotor settings respectively as well.

1. A lift thruster system for a VTOL aircraft, comprising:
one or more lifting thrusters contained within a housing,
wherein the housing includes one or more airflow manipulation devices provided on or associated with the housing and configured to manage the airflow into or through at least one of the one or more lifting thrusters.

2. The lift thruster system of claim 1, wherein the one or more airflow manipulation devices comprises a spoiler located about an intake of at least one of the one or more lifting thrusters.

3. The lift thruster system of claim 2, wherein the spoiler is located on a leading edge of the housing.

4. The lift thruster system of any one of claim 1 or 2, wherein the spoiler is deployable between a stowed state and a deployed state in which it extends at an angle to a surrounding surface of the housing.

5. The lift thruster system of claim 4, wherein in the stowed position the spoiler lies flush with the surrounding surface of the housing.

6. The lift thruster system of any one of the preceding claims, further comprising one or more vortex generators located about an intake of at least one of the one or more lifting thrusters.

7. The lift thruster system of claim 6, wherein the vortex generators are defined by respective stubs protruding from the adjacent surface of the housing.

8. The lift thruster system of claim 7, including a plurality of vortex generators grouped into at least one pair.

9. The lift thruster system of claim 8, wherein each pair grouping of vortex generators are arranged in a V-shape.

10. The lift thruster system of claim 9, wherein for at least one of the groups the vortex generators are arranged such that the vertex of the pair points towards a leading edge of the housing.

11. The lift thruster system of claims 6 to 10, wherein the vortex generators are movable between deployed and stowed positions.

12. The lift thruster system of any preceding claim, further comprising a closure arrangement to selectively close or open at least one of the respective intake or outlet of the one or more lifting thrusters.

13. The lift thruster system of claim 12, wherein the closure arrangement comprises a deployable door that is slidable over the respective intake or outlet.

14. The lift thruster system of claim 12, wherein the deployable door comprises a flexible sheet that is deployable from a powered spool.

15. The lift thruster system of claim 13 or 14, wherein the deployable door is deployed automatically in dependent of the flight mode of an associated aircraft.

16. The lift thruster system of claims 12 to 15, wherein the deployable door is located at the intake of a respective one of the one or more lifting thrusters.

17. The lift thruster system of any of claims 12 to 16, wherein the closure arrangement includes a louver system.

18. The lift thruster system of claim 17, when dependent on claim 16, wherein the louver system is located at a respective outlet of at least one of the one or more lifting thrusters.

19. The lift thruster system of any one of claims 1 to 18, further comprising an air curtain system arranged about a respective intake of at least one of the one or more lifting thrusters.

20. The lift thruster system of claim 19, wherein the air curtain system comprises one or more ports extending about a respective intake of at least one of the one or more lifting thrusters.

21. The lift thruster system of claim 20, wherein the one or more ports includes a first port located forward of one of the thrusters and adjacent a leading edge of the housing.

22. The lift thruster system of claim 21, wherein the first port extends laterally across the housing in a width direction for a length that is about the same as the diameter of the intake of the respective thruster.

23. The lift thruster system of claim 22, wherein the first port is non-linear in plan view so as to define a forward portion.

24. The lift thruster system of claim 23, wherein the forward portion points towards the leading edge of the housing.

25. The lift thruster system of any one of the preceding claims, wherein the housing contains a plurality of lifting thrusters.

26. The lift thruster system of claim 25, wherein at least two of the plurality of lifting thrusters are arranged in a row.

27. The lift thruster system of claim 26, wherein the row is aligned in a fore-aft direction.

25. An aircraft wing including a lift thruster system as claimed in claims 1 to 24.

26. An aircraft comprising a lift thruster system as claimed in any one of claims 1 to 24.
